(19) United States
(12) Patent Application Publication
(10) Pub. No.: US 2008/0298567 A1
(43) Pub. Date: Dec. 4, 2008

(54) WEB BASED TELEPHONE MANAGEMENT SYSTEM

(76) Inventor: Michael Leonard Guile, Cape Town (ZA)

Correspondence Address: BANNER & WITCOFF, LTD., 1100 13th STREET, N.W., SUITE 1200, WASHINGTON, DC, 20005-4051, US

(21) Appl. No.: 12/023,604

(22) Filed: Jan. 31, 2008

(30) Foreign Application Priority Data
Jan. 31, 2007 (ZA) 2007//00892

(51) Int. Cl. H04M 15/00; G06F 15/16

(52) U.S. Cl. 379/112.06; 709/206

(57) ABSTRACT

Technology that implements an integrated and automated process for delivery of low cost web based telephone management services, as an outsourced solution in the arena of voice management. The services are provided via the internet, from a web site, after installation in the customer premises the service can be rendered in all respects remotely and is automated to a high degree. This economises on costs and allows a high grade service previously only available to the upper end of the market to be available to essentially all segments.

This application claims priority of South African Application No. ZA2007/00892, filed Jan. 31, 2007. The disclosure is expressly incorporated herein by reference.

### FIELD OF TECHNOLOGY

This disclosure lies in the field of telephone management, which includes monitoring telephone usage, such as recording telephone call event information, the date, time, duration, dialled digits and cost of every call, and optionally other information.

### BACKGROUND

Information of this kind is consolidated to provide reports for use in company cost centres or accounts departments to activate invoicing or cost allocating. This information can also be used to discipline responsible use of telephone facilities in business contexts. The information can also be used to monitor the choice of service providers (i.e. carriers) so that telephone costs can be optimised, according to carrier, national, international and cellular calls and time of day. It is important for an end user of telephone services to understand the calling patterns and how best to route calls at least possible cost.

Two types of service are available for the above objectives, stand-alone software installed at the user and web based services accessed via standard browser software and provided by an Application Service Provider (ASP).

Stand-alone software is loaded onto a PC and connected to the telephone system {e.g. a private automatic branch exchange (PABX)}. This type of service is suitable for small operations, for example non-corporate companies, SME's and in general, where there are less than 30 extensions and the user requires to have the service on only one site. The software is sold as an add-on to the telephone service, the attention of the user is concentrated on the telephone system, and the user pays little attention to the telephone management system in the buying decision. The software must be updated on site when telephone rates and other features change as well as problem solving and debugging. The visit to the user's premises must be either charged or supplied free.

Web based services are managed services provided by an Applications Service Provider, the cost is high compared to that of stand alone services and has thus far been sold only to corporate businesses who have expert telecommunication departments who are able to see the cost benefits of telephone management services. Because of its cost and because installation is a complex procedure the web based services have in general not been sold to the first mentioned group of businesses.

### BRIEF SUMMARY

The present disclosure provides an integrated and automated Business Process for delivery of low cost web based telephone management services, as an outsourced solution in the arena of voice management. The services are provided via the internet, from a web site, after installation of data collection equipment or software in the customer premises the service can be rendered in all respects remotely and is automated to a high degree. This economises on costs and allows a high grade service previously only available to the upper end of the market to be available to essentially all segments.

A significant feature that is also enabled by the disclosure is that selected facilities of the web based system can be made available to the sales partner company, i.e. the dealer that supplies the telephone PABX. This enables that company to access data that is useful for market analysis and marketing as well as enhancing their service delivery. All this is enabled by the disclosure and secure web servers house all production systems and database collection.

To support the service a well-defined and automated Business Process integrates software modules into a “holistic system”. This has the potential to provide a versatile and flexible facility designed to meet both multiple site and single site telephony management requirements on both large and small organisations.

This provides a holistic Business Process that includes services and products and the merging of separate systems into one. A central point of control reduces the cost of maintaining a telephone management system on individual sites.

The Business Process supports high volumes and low per unit revenues, because of its high degree of integration and automation.

The Dealer is able to configure the web service remotely without intervention from web-based ASP staff.

The CRM package is updated automatically, so that one is able to provide the appropriate services for the Distributor, Dealer and the End User.

The invoicing engine is automatically updated.

The marketing process to encourage customers to upgrade to a “paying” service package is automated. Reports and information have been developed and are sent to the customer on a scheduled basis.

The End User, via the Web Server can set automatic reports. These reports may be chargeable.

All the above modules are synchronised to create a business process greater than the sum of its individual parts.

The disclosure may be applied for the purpose of collecting data generated by applications or devices that produce event information in various formats.

The PABX may output call records in one of the following manners:

### 1. Serial

2. IP data
3. A file

The Data Collection software or equipment software is used at client's premises to collect call record data from PABX systems and ship the data to the ASP web site.

The Data Collection software client collects data from multiple data sources, compresses the data, encrypts it, and e-mails it to a specified e-mail address at the provider web site. Currently three types of data sources are supported: Serial data source, and File data source, and IP data collection.

The service can package and send available data periodically based on a specified time interval. To prevent loss of data there is a confirmation system, when this is turned on a record of every data mail that was sent is kept. If a confirmation is not received, a process is initiated to resend and ensure successful delivery of the data.

The service e-mails data to the website using standard SMTP mail IMAP or HTTP. Incoming mail to the Package is via POP3, IMAP or HTTP. Incoming mail is desirable but not essential as the Dealer/User will be notified if data has not been received for 48 hours or other configurable period.

The service can also deliver the data by telephone line. The program dials a local POP, authenticates itself and sends an e-mail to the web site.

The service software is a Java program, there is a Linux and a Windows version of it. The PC should be reliable and should never be switched off. The minimum specification for the PC is that of the operating system used.

Installation requires that the service PC is connected to the PABX. This is generally through a RS232 serial port or via a standard LAN (Local Area Network) point. Standard RS232 specifications apply to the connection.

Customer training is conducted remotely by means of a script, delivered over the telephone by a help desk, the on-line help is very detailed relating to the screen that is called up by the customer and by the help desk, both from the web site, this allows complete confidence in bringing solutions to customers. Where a low end package is initially chosen by a customer this can be upgraded again via the internet access.

The disclosure also provides dealer training, analysis tools are exclusively available to the dealer which empowers the dealer to optimise the service provided by the telephone system that the dealer has installed, because the dealer has access through this feature of the disclosure to information about the usage made by the customer, showing shortcomings and optimisation opportunities as well as economising possibilities.

### BRIEF DESCRIPTION OF THE DRAWINGS

The foregoing summary of the disclosure, as well as the following detailed description of illustrative embodiments, is better understood when read in conjunction with the accompanying drawings, which are included by way of example, and not by way of limitation with regard to the claimed disclosure.

FIG. 1 is a block diagram schematic of the functionality of the telephone management service.

FIG. 1A is a more graphic illustration of the architecture of the disclosure.

FIG. 2 is a sequential description of the installation process.

FIG. 3 describes an adapter.

FIGS. 4 to 7 show screens used in the service.

FIGS. 8 and 9 show examples of fault finding flow charts for two types of PABX.

### DETAILED DESCRIPTION OF THE DRAWINGS

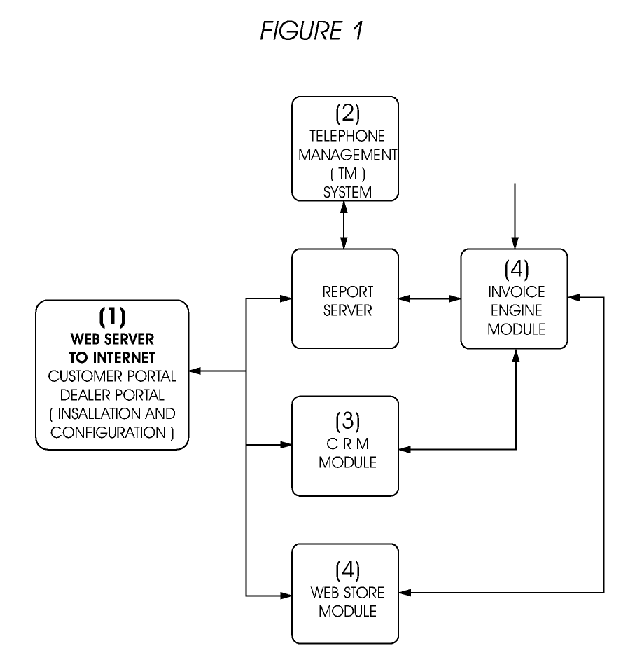

In the following description of the various embodiments, reference is made to the accompanying drawings, which form a part hereof, and in which is shown by way of illustration various embodiments in which the disclosure may be practiced. It is to be understood that other embodiments may be utilized, and structural and functional modifications may be made without departing from the scope of the present disclosure. FIG. 1 shows the main functional elements of the system, namely the web server to the internet, providing the customer portal and the dealer portal, the latter for installation and configuration, via the integration module, the telephone management server, the report server, the invoice engine module, the CRM module and the web store module. As shown in FIG. 1A, a client secure environment includes one or a series of PABX installations, for example data collection equipment (SS40, a Nikon and a LAN buffer) or software tele-mail server. These may be linked through to a data concentrator from which data may pass through a firewall or may transmit the data direct to the web site or these devices may communicate directly with the web site, a web browser is used for viewing reports generated from the data. The disclosure provides an email and internet connection with encryption both before and after the email transmission. This transmits data to and from a data centre (a UUNET is not necessary), via a firewall, where a mail server and/or data collection server passes to a call processor, in the TT secure environment, thus to a database and a web server. The disclosure employs software at the client's premises to collect data from one or multiple sources, compress and encrypt it and email it to a specified email address at the disclosure web site. This is done at specified time intervals, a confirmation system prevents loss of data and a re-send protocol is activated in the event of a failed transmission. SMTP and POP3, IMAP or HTTP technology can be used. Java, Linux and Windows options can be used, the disclosure is implemented in a computer that is connected to the PABX, generally through a RS232 serial port or Local Area Network connection, for convenience.

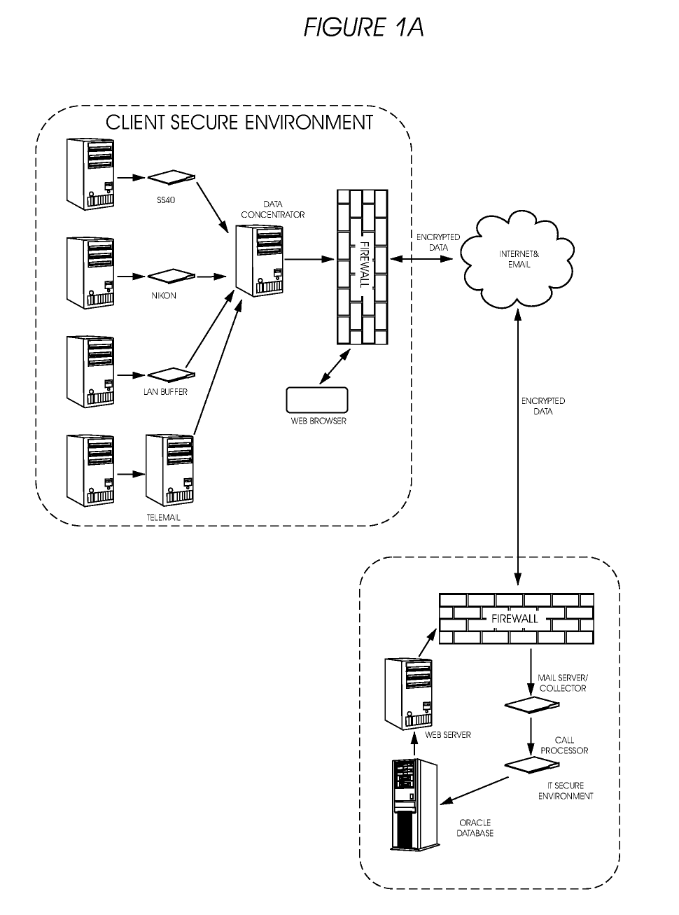

FIG. 2 shows the sequence of steps undertaken for the installation process, the text shown in the blocks is incorporated in this description by reference.

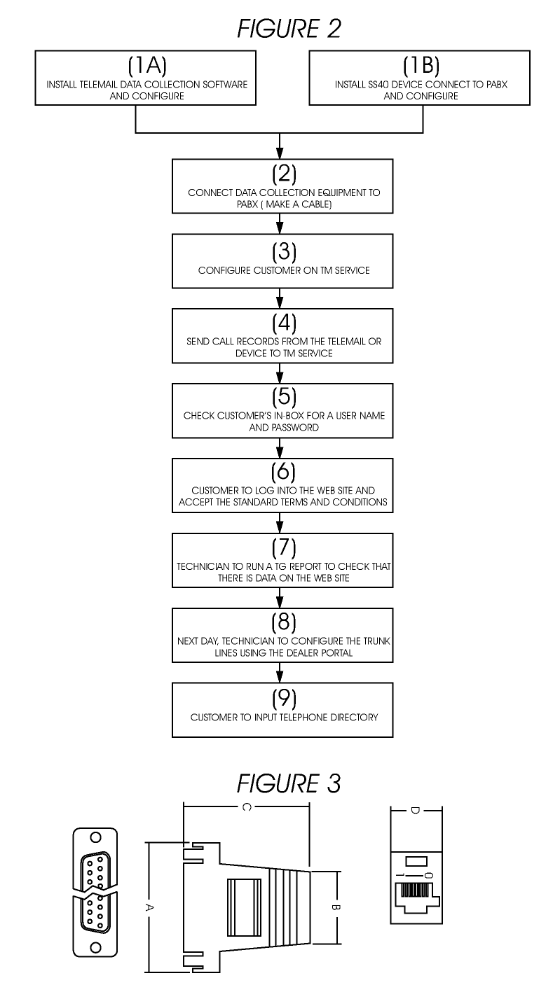

FIG. 3 shows an adapter supplied to the user to facilitate a “plug and play” installation process.

The adapters are assembled to specified design specifications. There are 9 pin and 25 pin plugs suitable for all PABX and data collection devices. The PABX and the data collection device each require an adapter, the adapters are joined via a standard RJ11 telephone cable that can be purchased from supplier or from the hardware section of most supermarkets.

To configure the customer on the web server, key cards are used. These are cards containing a unique licence number, which is required when configuring a customer. The unique number licenses the user and provides a tracking number in the Distribution channel. The tracking number tracks the Distributor and the Dealer instrumental in acquiring the customer.

A preferred practical feature is a specially adapted plug for connection from the PABX to the data collection device with appropriate pin connections and loop back connections, according to the type of device.

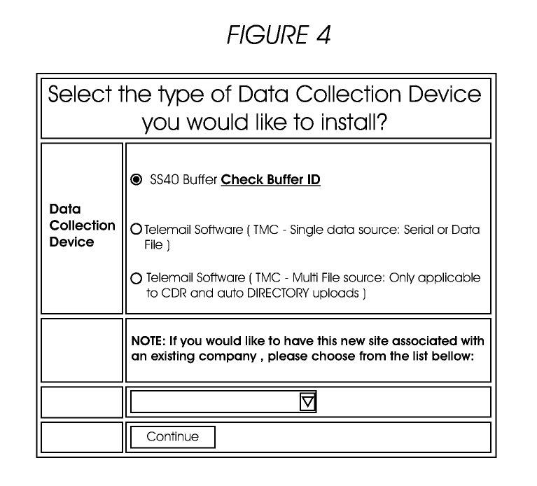

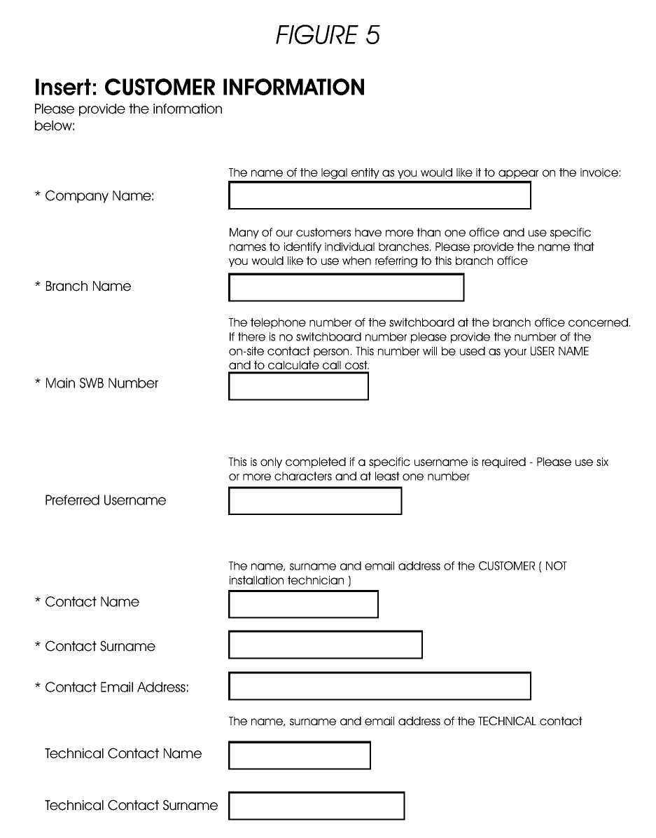

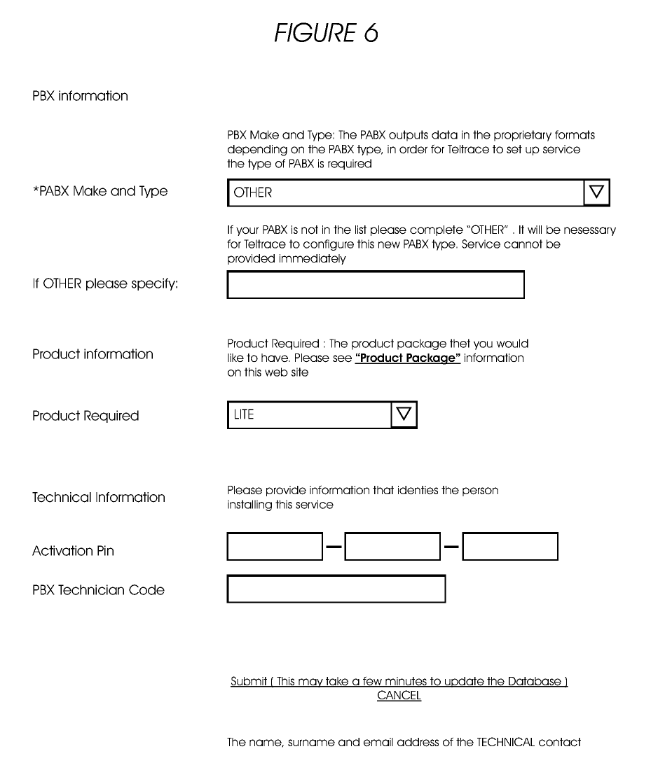

The data collection method can be chosen from many available alternatives. FIG. 4 to 6 show screens that can be used, selected information from them is inserted into the database of the telephone management server, the report engine and the CRM module.

When some call records have been recorded, they are sent to the telephone management service web site for processing. The user name and password are automatically generated when the customer is configured. The user name and password can be checked in the specified user's in-box. An email is sent containing the information to allow checking. The customer logs into the telephone management service and accepts the standard terms and conditions. Data is placed in a report generated from call records that have been processed, if not, a faultfinding procedure is initiated. The service is left running for 24 hours and the telephone monitoring service web site is opened and the trunk lines are configured, with the dealer menu. The customer inputs a telephone directory.

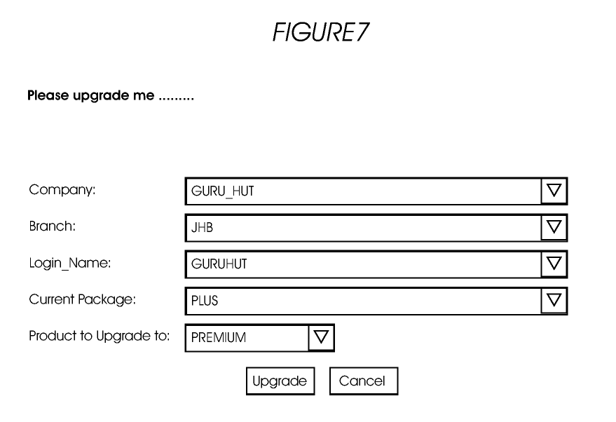

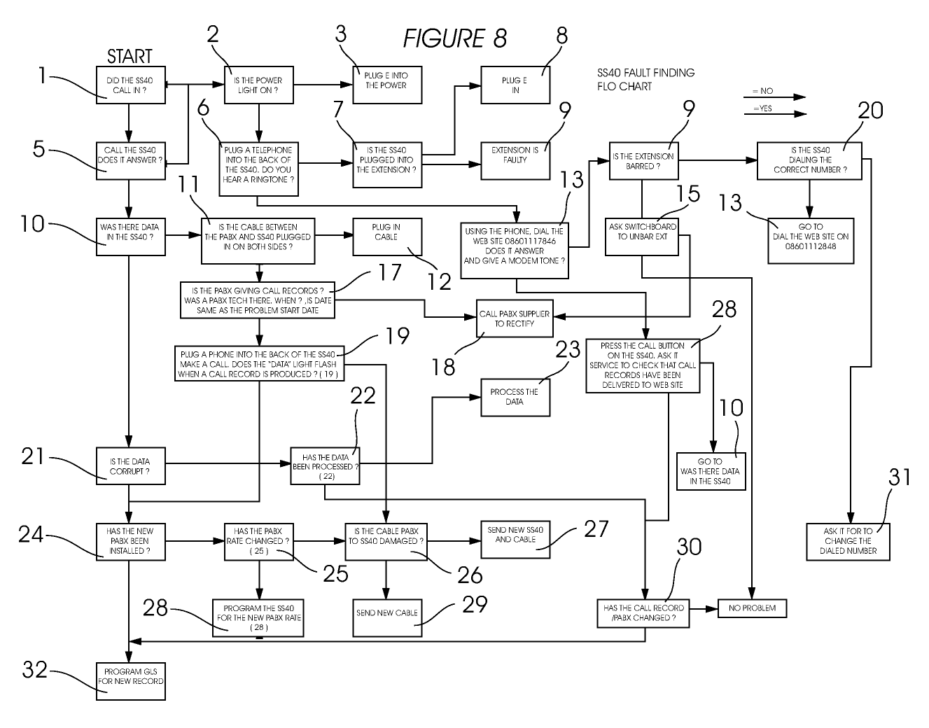

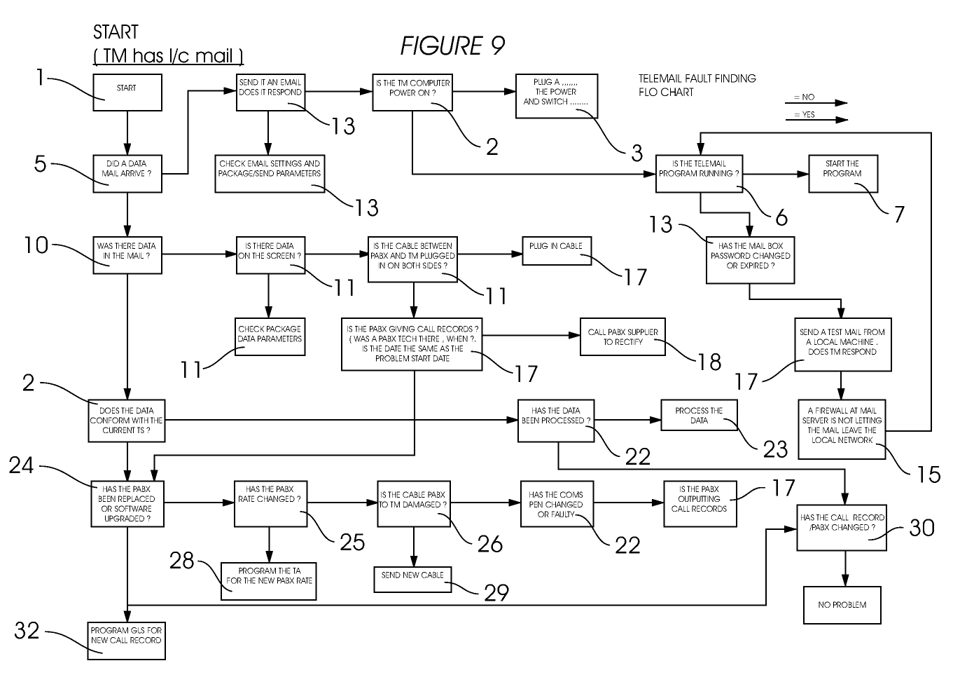

See FIG. 7. Every billing period the invoicing engine will query the CRM database for all End Users and dealers that must be billed.

Using the customer information from the CRM, the Invoicing Engine will then query for each End User or dealer:
the Report Server for reports that have been set and that are chargeable,
the TMS Server to establish the number of ports in use for each customer and charge accordingly.
the Web store for purchases made during the billing period
the CRM for chargeable service calls
   and will then compile an invoice containing the following information:
   1. The customer information, name, address, tax number etc;
   2. the number of ports chargeable and the cost per port
   3. the number of chargeable automated reports from the report server
   4. the quantity of service calls and costs applicable from the CRM
   5. purchases made during the period from the web store
   6. Any of other chargeable items

Through the Web Server, the End User is able to set and delete reports to be scheduled and delivered at specific times to specific e-mail addresses, for example, a report that must be delivered to an individual at the end of every month or every week or every day. The report Server will, at the appropriate time, automatically query the TM Server, assemble the result and deliver the report to the selected destination. Some of these reports may be chargeable and therefore a record must be kept of reports sent so that they can be invoiced at the close of the billing period.

The objective of the marketing cycle is to encourage the End User to upgrade to a higher value Service Package and to make purchases from the Web Store.

After installation, there is a programmable period where the End User receives no marketing material. On commencement of the marketing cycle material and information in the form of;
facilities
reports
sales material
special offers
   will be made available to the End User for a temporary and programmable period of time The process of receiving, demodulating, and decoding of a full bandwidth DVB-T signal would require substantial power and such power is not at the disposal of small handheld battery operated devices. To reduce the power consumption in handheld terminals, the service data is time-sliced, often by an IP encapsulator 105, before the service data is sent into the channel. When time-slicing is used, the data of a time-sliced service is sent into the channel as bursts, so that the receiver 107, using the control signals, remains inactive when no bursts are to be received. This reduces the power consumption in the receiver terminal 107. The bursts are sent at a significantly higher bit rate and an inter-time-slice period is computed such that the average bit rate across all time-sliced bursts of the same service is the same as when conventional bit rate management is used. For downward compatibility between DVB-H and DVB-T, the time-sliced bursts may be transmitted along with non-time-sliced services.

For example, a specific report not normally available to the End User will be made available for a period of one month. The End User will be encouraged to ‘sign up’ for the report that will have and additional cost attached and will be invoiced accordingly.

There are several “Service Packages” available to the End User with varying levels of functionality and costs. The End User is able to “upgrade” the Package via the Web Server. This change in the customer's status is automatically reported to the Invoicing engine, the CRM and the TM Server.

The telephone management web services (ASP services) will be available to smaller organisations for whom stand-alone solutions were previously the cheapest option, or the only option, the service can be delivered through traditional distribution channels of distributor, dealer and end user as is presently used by stand alone software vendors.

The Business Process necessitates branding the service with a Dealers logo, trademarks and colours.

A CRM Module (Customer Relationship Management) is used by the Service Department in order to manage the customer interactions, It contains information from the Web Server Installation Forms. All service calls, chargeable and non-chargeable, are recorded here. This database is queried by the Invoice Engine every billing period so that the chargeable service items are included in the Invoice.

The End User, and the Dealer will have access to a Web Store where purchases can be made for related and unrelated services and products. The amount spent will be subject to the customer's credit limits as held in the CRM Module. Every billing period the Invoicing Engine queries the Web Store for purchases and adds them to the invoice.

### Web Server

The Web Server allows access to sets of reports and forms depending on the User Name and on the status of the User. For example a Dealer will have access to the installation forms, where an End User will only have access to reporting and general End User functions. There are three basic levels of access with variations on these, dependant on the User Name. The number of levels of access can be increased or decrease at any time to support the marketing plan.

| Access level | Variations | Notes |
|---|---|---|
| End User | Service Packages | More service packages can be added, |
| | Lite | names used are for marketing only |
| | Pus | and have no specific definition. |
| | Premium | |
| Dealer | With Branding | A Dealer by choose to have the |
| | Without Branding | service branded with his logo |
| | | trademark and colours or may elect to |
| | | use provider branding. |
| | | The Dealer has access to the |
| | | information all reports forms etc., for |
| | | all sites installed by the Dealer. |
| Distributor | | The Distributor has access to the |
| | | information all reports forms etc., for |
| | | all sites installed by his Dealers. |
| Global Access | | The system administrator has access |
| | | to all information and forms for all |
| | | sites installed. |

This is a managed service, the End User and the Dealer will be notified by e-mail if there is a problem with the on-site equipment enabling a fast recover/fix. This is not possible on stand-alone software, the end user finds out it is broken when he tries to run reports at the end of the month.

Also a lower price. In line with Internet application trends worldwide, entry-level service is free of charge, with a small charge for a higher service level.

A Dealer Portal provides the Dealer with a view of his customer base including all data and reports. This empowers the Dealer to offer higher levels of service to the End User. The Dealer can ensure that the on-site customer equipment, PABX and associated equipment is running effectively by checking reports. For example, the dealer can tell whether the end user of the PABX requires additional extensions, has cell-phone overflow, has sufficient cellular least cost routing or in general has sufficient capacity to support routing telephone calls over the preferred carrier or if the telephone management system has ceased to provide information, and others.

A user at the remote site is able to schedule any report from the web browser customer interface and the report may be a chargeable or not chargeable item, in which the user at the remote site setting the automatic scheduled report informs a report engine, an invoice engine and a CRM and actions are executed appropriately.

The cost of providing the software/service to the customer is reduced giving him (the Dealer) a price advantage over a competing Dealer.

The Dealer can generate additional income by using the report information to identify problems and opportunities, thereby generating addition revenue from service calls and selling appropriate additional products and acting as an agent for companies whose primary business is to carry voice traffic.

The Dealer portal will be branded with Dealer logos etc., this increases the Dealers credibility. The End User accesses the Service via the Dealer's website increasing the number of hits on the Dealers web site and increasing marketing opportunities.

The Distributor and the Dealer will have access to marketing information from his customer base.
The number of extensions in use at a customer
The total cost of telephone calls generated by that customer and the type of calls made, cell, national, international.
the make, model and software version of the PABX.
A user at the remote site accesses the dealer's web site, on which there is a button by which he activates an option whereby he is diverted to a web site with a generic name in which all pages are branded with the dealer's colours, logos, trade marks and other identifying indicia.

The Distributor can use this very valuable marketing information to sell appropriate products to its customer base.

What is claimed is:

1. A communication process between a host site and a remote site for information in electronic format from various sources to be collected from the remote site and transported reliably and securely via electronic means to the host site, using intelligent applications at both the remote site and host site, in which the remote site receives data from a suitable port by accessing a file from a shared directory and or querying a database, listening on a serial port or an information processing Internet Protocol (IP) port, then storing the data at the remote site and periodically transporting the data to the host site via a connection from the remote site to one selected from the internet, a dial-up telephone link to an internet service provider and direct to modems at the host site, using a receipt confirmation protocol, the host site on receipt of the data opens the message, checks the data and processes same.

2. A communication process as claimed in claim 1, in which the remote site receives data from one selected from a serial port and an IP port, and where data is sent by outgoing mail from the remote site using protocols selected from Simple Mail Transfer Protocol (SMTP), Internet Access Access Protocol (IMAP), Hyper Text Transfer Protocol (HTTP) and other standard mail protocols and incoming mail to the remote site uses a protocol selected from Post Office Protocol #3 (POP3), IMAP, HTTP and other standard mail protocols.

3. A communication process as claimed in claim 1, in which the email or message is given a unique serial number consisting of a unique remote site identifier and a sequence number of the email or message, once the data has been sent it is stored in a confirmation folder until it receives a confirmation notification from the host that the email or message has been received and the data is intact, whereupon the email or message and data are deleted from the confirmation folder, the remote site re-sending emails until the confirmation folder is empty.

4. A communication process as claimed in claim 3, in which the host site upon receipt of an email opens the email, checks that the data is intact, loads the unique sequence number of the email in a table and stores the data for processing, or if the number is already loaded deletes the email and data and does not process the data.

5. A communication process as claimed in claim 1, which is applied to an integrated and automatic delivery of low cost web based telephone management services and in which certain modules are integrated to form a holistic enterprise resource planning system, all data primarily kept in a managed database environment.

6. A communication process as claimed in claim 5, in which the process integrates one or more modules selected from manufacturing, supply chain, financial information, customer relationship, web store, human resources and warehouse management.

7. A communication process as claimed in claim 5, in which access to data by a third party distributor or dealer is incorporated by use of a log in user name and activation personal identification number which is a unique license number to allocate appropriate sites to the distributor, to enable the distributor to view information from the appropriate sites.

8. A communication process as claimed in claim 7, in which a user at the remote site accesses the dealer's web site, activates an option whereby he is diverted to a web site with a name in which all pages are branded with the dealer's colours, logos, trade marks and other identifying indicia essentially branding the service for the dealer.

9. A communication process as claimed in claim 1, in which an automated marketing campaign enables individual system features for a limited period of time and sends promotional emails to an end user at a remote site, encouraging an update to a higher package.

10. A communication process as claimed in claim 1, in which the host site has a web interface that allows the dealer to self configure and later edit the technical requirements of the process.

11. A communication process as claimed in claim 1, in which automated invoicing is incorporated in billing periods in which an invoicing engine sends queries for one or more items selected from chargeable service items, number of extensions, package level, and the web store for any purchases made, then automatically generates an invoice and emails it to one selected from an end user at the remote site, a dealer for referral to the end user, an end user directly on the dealer's behalf and the Dealer only, for payment of services rendered to its customer base.

12. A communication process as claimed in claim 1, in which a user at the remote site is able to schedule any report from the web browser customer interface and the report may be a chargeable or not chargeable item, in which the user at the remote site setting the automatic scheduled report informs a report engine, an invoice engine and a Customer Relationship Module (CRM) and actions are executed appropriately.

13. A telephony system to which is applied a communication process as claimed in claim 1.

14. A method of installation of apparatus for integrated and automated delivery of low cost web based Application Service Provider (ASP) telephone management services, as an outsourced solution provided via the internet, which comprises the steps of installing in a client secure environment, a data store, data links from the store connected to a telephone system, means which ports the data via electronic means, installing a management services secure environment mail server, or data collection environment call processor, data centre and web server on a web site, the mail server adapted to collect, forwards it to the call processor, which processes the data, loads the processed data as valuable information onto the data base, which via the web server makes it available to the client, distributor or dealer.

15. A method of installation of apparatus for integrated and automated delivery of low cost web based telephone management services as claimed in claim 14, in which the data store includes a data concentrator and the concentrated data is encrypted and transmitted.

16. Apparatus for integrated and automated delivery of low cost web based telephone management services, as an outsourced solution provided via the internet, which comprises in a client environment one or more computers or intelligent devices connected to a telephone system, data acquisition links from the computer(s) to a data store which encrypts the data and sends it, by email or other electronic means to one selected from a web site in the internet, a management services secure environment mail server and data collection server, that collects the data, forwards it to a call processor, which processes the data, loads the processed data as valuable information onto a data base, which via a web serve makes it available to one selected from the client, the distributor and the dealer.

17. Apparatus as claimed in claim 16, in which the client environment is secure environment and the data is concentrated in the data store.

18. Apparatus as claimed in claim 16, which includes a cable installation kit having one or more selected from an envelope containing an activation pin, a pre-configured adapter for a selected private branch exchange, a pre-configured adaptor for a selected data collection means and a pre-configured cable to connect the adapters in a plug and play manner.

19. Apparatus as claimed in claim 16, which includes means to collect call records from a private automatic branch exchange selected from one of a serial port, IP data port and a file.

20. Apparatus as claimed in claim 16, which also provides dealer assistance by means of analysis tools which are exclusively available to a dealer which empowers the dealer to optimize the service provided by the telephone system and services at the mote premises, providing the dealer access through the tools to information about the usage made by the end user, showing shortcomings and optimization opportunities as well as economizing possibilities.
